(19) United States
(12) Patent Application Publication
(10) Pub. No.: US 2024/0118096 A1
(43) Pub. Date: Apr. 11, 2024

(54) LOCALIZATION AND PATH PLANNING OF ELECTRIC SYSTEMS DURING DYNAMIC CHARGING

(71) Applicant: Hitachi, Ltd., Chiyoda-ku (JP)

(72) Inventor: Subrata Kumar KUNDU, Canton, MI (US)

(21) Appl. No.: 17/962,249

(22) Filed: Oct. 7, 2022

(51) Int. Cl. G01C 21/34; B60L 53/12; B60W 60/00

(52) U.S. Cl. CPC G01C 21/3461; B60L 53/12; B60W 60/001; H04W 4/024

(57) ABSTRACT

Example implementations described herein involve systems and method which can include receiving, from a connected automated electric vehicle (CAEV), vehicle information related to operation of the CAEV; determining one or more candidate routes to a destination of the CAEV based at least on the vehicle information; determining whether the CAEV is on a road segment of the one or more candidate routes to the destination having a dynamic charging system; and sending, to the CAEV, a path planning trajectory while identifying a localization accuracy of one or more sensors of the CAEV to update the localization accuracy of the CAEV based on a battery of the CAEV being charged with the dynamic charging system along the one or more candidate routes.

### BACKGROUND

### Field

The present disclosure is directed to electric systems, and more specifically, to systems and methods involving localization and path planning of electric systems during dynamic charging.

### Related Art

There are generally two different ways to charge electric systems (e.g., electric vehicle (EV) or any other system that utilizes a battery as a power source)—wired and wireless charging. Wireless inductive charging allows EV to charge automatically without a wire while driving on the road. For efficient charging of an EV, correct alignment between the transmitter coil (e.g., located on the road) and receiver coil, within an EV, should be aligned properly. As such, EVs should follow specific trajectory on the road based on the transferring coil location. There are related art implementations that show how to define the trajectory of EV considering transmitter coil location to maximize the battery charging rate. However, each vehicle's battery life and state of health (SOH) is different, and thus optimum trajectory that can ensure the best charging rate considering maximum life is required.

Moreover, as the locations of the transmitter coil on the road are known as well as the battery charging rate can be monitored from EV battery management system, therefore this information can be utilized to determine the correct location of the vehicle. The determined localization info can further compare with the localization values of in-vehicle sensor and consecutively can update the calibration parameter of the sensor to improve the localization accuracy.

The research and development of technologies and solutions on electric vehicles (EV) have gained significant momentum during the last decades in order to realize sustainable society and resilient transportation systems. Recent advancement of sensing, artificial intelligent (AI), connectivity, and automation technologies also widens the opportunity to bring improved safety, comfort, and efficiency of electric vehicles. Connected automated electric vehicles (CAEV) will play major role in future connected EV eco-system for achieving sustainable and resilient mobility system. However, range anxiety, battery life and realizing high level of automated driving may be challenges for CAEVs. To solve the aforementioned issues, several related art implementations have been proposed.

In one example related are implementation includes a system for dynamic electric vehicle charging with position detection. Such systems detect an arrival of the EV at a charging circuit to control an activation or deactivation of the charging circuit. The system may receive information about the EV's location, velocity, or direction vector.

In another example related art implementation, there is a system for wireless charging of a vehicle power source. Such related art implementations discuss the wireless charging of an electric vehicle, where the location of a charging transmitter can be determined based on a charging marker. Thus, a path planning trajectory can be determined for charging of the vehicle.

### SUMMARY

The present disclosure involves path planning trajectory of individual EVs considering its battery SOH and SOC (state of charge).

Therefore, the present disclosure also involves techniques to improve localization accuracy of in vehicle sensors using charging rate info and transmitter receive coil info that can ultimately improve the performance of automated vehicle control. The details procedure to determine path planning trajectory and localization using connected cloud platform and/or vehicular edge controller (VEC) and in vehicle ECU information are explained in this present disclosure.

Example implementations described herein involve a novel technique for path planning and localization of CAEVs during dynamic charging that will ensure efficient charging of the EV battery and a high level of automated driving by avoiding localization error. Additionally, example implementations may bring significant benefits to create novel connected electric vehicle applications as well as to improve and expand the functionalities of connected mobility platforms, sensors, edge controllers, and AD electronic control unit (ECU).

Example implementations as described herein utilize battery charging rate for localization and path planning of EV for efficient charging.

Recent technological advancements as well as favorable government policies and incentives, there's been a rise in electric vehicle (EV) adoption and connected automated mobility services to realize a carbon-free, accident-free society. Electric vehicles have gained significant attention during the last two decades due to their lower operating cost as well as minimum air pollution and green house emission. With the global economic growth and urbanization, roads become busier nowadays. Thus, ensuring zero emission with safe driving becomes a key factor for transportation and mobility service business. Connected automated electric vehicles (CAEV) will play a major role in future connected automated EV eco-system for achieving such sustainable and resilient mobility system. Therefore, the present disclosure involves a localization and path planning technique for realizing improved automated vehicle control and better efficient charging of CAEV.

An electric vehicle can be refilled with energy in different ways including battery charging, battery swapping, and so on. Battery charging technique of an EV can be generally classified into two categories—wired charging using stationary charging stations and wireless charging on dynamic charging lanes. Wired charging is more common where vehicles are charged using different kind of chargers (Level-1, Level-2, direct current fast chargers). The refilling time of wired charging is still much longer compared to the refueling time of a conventional internal combustion engine vehicle. Therefore, to improve efficiency and comfort to refill energy of an EV, wireless charging techniques have gained significant momentum nowadays where an EV is charged while driving on dynamic charging lanes.

There are two types of charging techniques used for dynamic charging lanes—conductive charging and inductive charging. Conductive charging is a kind of wired charging technique on dynamic charging lanes where overhead electric cables or beams are connected with the vehicle to charge it. Wireless inductive charging allows EV to charge automatically without wire while driving on the road. The efficiency of a wireless inductive charging is close to the efficiency of wired charging techniques. In inductive charging, magnetic coupling to transmit electric power wirelessly from the source to the electric vehicle is realized using two electric coils — transmitter coil on the ground and receiver coil on the vehicle. For efficient charging of an EV, correct alignment between transmitter and receiver coil is desirable. Maximum charging rate of an EV battery is attainable when the receiver coil is aligned with the transmitter coil. Since the transmitter coil's location is fixed on the ground, (e.g., under the road), therefore by monitoring charging rate, it is possible to locate the location of a vehicle on the road. As a result, accurate localization information of vehicle can significantly improve the automated driving control of the electric vehicle.

In an example implementation involving an EV, at the beginning of a trip, a connected automated electric vehicle (CAEV) shares its current location and destination with a connected vehicle data management platform (e.g., FALCON®). Based on the connected vehicle's occupant specified destination otherwise predicted destination based on users and time, the connected vehicle data management platform identifies the road that has inductive wireless charging that allows the CAEV to charge automatically without wire while driving on the road. The connected vehicle data management platform determines the best efficient route that will maximize the battery state of charge (SOC) after the trip. Once the destination route has been finalized, the route is divided into multiple road segments and waypoints based on automated driving capability of the vehicle. The connected vehicle data management platform shares the connected vehicle information, its battery SOC and SOH, and expected arrival time of the vehicle to the corresponding road segment vehicle edge controller (VEC). Once the vehicle approaches a road segment, the VEC of the corresponding road segment sends the lane information and lateral & longitudinal path planning trajectory (e.g., way point) to the vehicle for optimum charging considering better battery life. VEC and/or the connected vehicle data management platform calculates a charging rate of the vehicle for each of the waypoints utilizing power source capacity and consecutively sends to the vehicle electronic control unit (ECU). The localization module of the ECU compares the charging rates received from the VEC or the connected vehicle data management platform, battery management system, and identifies the location of the vehicle. In case the charging rate for any way point is more or less than a threshold value, vehicle ECU sends localization error signal to localization algorithm. The vehicle ECU updates sensor calibration parameters and compares the localization accuracy for the next waypoint. Once the vehicle localization using updated sensor's calibration parameters results accurate charging rate compared to the VEC or the connected vehicle data management platform charging rate, the vehicle ECU confirms the localization module accuracy of the connected CAEV. As vehicle localization accuracy is critical to realize high level of automated vehicle control, updating the vehicle's localization accuracy comparing battery charging rate data could bring significant benefits to improve CAEV performance.

Aspects of the present disclosure include a method that involves receiving, from a connected automated electric vehicle (CAEV), vehicle information related to operation of the CAEV; determining one or more candidate routes to a destination of the CAEV based at least on the vehicle information; determining whether the CAEV is on a road segment of the one or more candidate routes to the destination having a dynamic charging system; and sending, to the CAEV, a path planning trajectory while identifying a localization accuracy of one or more sensors of the CAEV to update the localization accuracy of the CAEV based on a battery of the CAEV being charged with the dynamic charging system along the one or more candidate routes.

Aspects of the present disclosure further include a computer program storing instructions that involves receiving, from a connected automated electric vehicle (CAEV), vehicle information related to operation of the CAEV; determining one or more candidate routes to a destination of the CAEV based at least on the vehicle information; determining whether the CAEV is on a road segment of the one or more candidate routes to the destination having a dynamic charging system; and sending, to the CAEV, a path planning trajectory while identifying a localization accuracy of one or more sensors of the CAEV to update the localization accuracy of the CAEV based on a battery of the CAEV being charged with the dynamic charging system along the one or more candidate routes.

Aspects of the present disclosure include a system that involves means for receiving, from a connected automated electric vehicle (CAEV), vehicle information related to operation of the CAEV; means for determining one or more candidate routes to a destination of the CAEV based at least on the vehicle information; means for determining whether the CAEV is on a road segment of the one or more candidate routes to the destination having a dynamic charging system; and means for sending, to the CAEV, a path planning trajectory while identifying a localization accuracy of one or more sensors of the CAEV to the update localization accuracy of the CAEV based on a battery of the CAEV being charged with the dynamic charging system along the one or more candidate routes.

Aspects of the present disclosure can include a system that involves means for receiving, from a connected automated electric vehicle (CAEV), vehicle information related to operation of the CAEV; means for determining one or more candidate routes to a destination of the CAEV based at least on the vehicle information; means for determining whether the CAEV is on a road segment of the one or more candidate routes to the destination having a dynamic charging system; and means for sending, to the CAEV, a path planning trajectory while identifying a localization accuracy of one or more sensors of the CAEV to update the localization accuracy of the CAEV based on a battery of the CAEV being charged with the dynamic charging system along the one or more candidate routes.

### BRIEF DESCRIPTION OF DRAWINGS

FIG. 1 illustrates a wireless EV charging system, in accordance with an example implementation.

FIG. 2 illustrates a plurality of resources to process computation tasks of a CAEV, in accordance with an example implementation.

FIG. 3 illustrates a schematic diagram of a system architecture, in accordance with an example implementation.

FIG. 4 illustrates a schematic drawing of a connected vehicle data management platform, in accordance with an example implementation.

FIG. 5 illustrates an example flow diagram that can be executed by the connected vehicle data management platform.

FIGS. 6A and 6B illustrate examples of potential routes available from a start to a destination.

FIG. 7 illustrates an example flow diagram that can be executed by a vehicular edge computing device.

FIG. 8A illustrates an example of transmitter and receiver coils used in dynamic charging.

FIG. 8B illustrates an example of coil misalignment in a lateral direction.

FIG. 9 illustrates an example of an induction wireless charging system.

FIGS. 10A and 10B illustrate examples of mutual inductance variance in a receiver coil.

FIG. 11 illustrates an example of a control architecture for an automated driving system.

FIG. 12 illustrates an example computing environment with an example computer device suitable for use in some example implementations.

FIGS. 13A and 13B illustrate examples of intersections according to some implementations.

FIG. 14 is a flow diagram illustrating an example process for determining precautionary observation zones (POZs) according to some implementations.

FIG. 15 illustrates an example of determining a POZ according to some implementations.

FIG. 16 illustrates an example of determining a POZ according to some implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Connected automated electric vehicles (CAEV) will play major role in future connected EV eco-system for achieving sustainable and resilient mobility system considering technological advancements as well as favorable government policies and incentives. A CAEV is an electric vehicle (EV) that has connectivity to other devices using one or more communication technologies as well as capabilities of automated driving or advanced driver assistance systems (ADAS). EV's can be generally classified into three categories— (a) Fully/All electric vehicle which also known Battery Electric Vehicle (BEV) (b) Plug-in Hybrid Electric Vehicle (PHEV) and (c) Hybrid Electric Vehicle (HEV). A BEV has no internal combustion engine and always operate by electric motors using energy from the battery. PHEVs are operated either by an internal combustion engine using energy from gasoline, or an electric motor using energy from the battery. Both of BEVs and PHEVs batteries can be charged by plugging the vehicle into charging equipment. A HEV is similar to a PHEV as both are operated either by internal combustion engine or electric motors. However, A HEV battery is charged through regenerative braking not by plugging in.

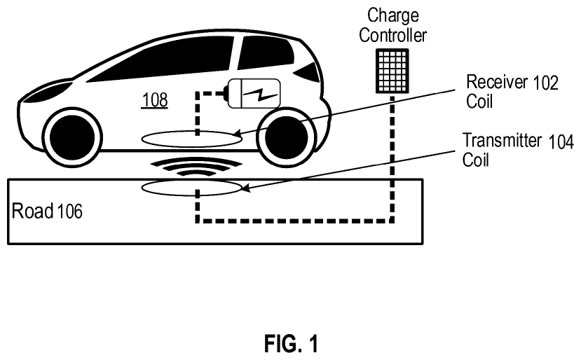

FIG. 1 illustrates a wireless EV charging system, in accordance with an example implementation. BEV and PHEV are generally designed for wired charging like their battery is charged by plugging in the vehicle with the charring equipment. However, these vehicles battery can be also charged using wireless technology. The wireless charging of electric vehicles is based on the principle of inductive coupling. In this technique, two electrical coils (transmitter 104 and receiver 102) are arranged in such a way that a change in electrical current in one coil (e.g. transmitter) induces electrical voltage across another coil (e.g., receiver) through electromagnetic induction and thereby energy transfers from the transmitter coil to the receiver coil. In inductive wireless charging technique of EVs, transmitter coils are placed under or within the road 106 or surface and receiver coil 102 is integrated with the vehicle 108.

Wireless charging of electric vehicle allows users to charge their vehicle not only in specific charging station but also in home, parking lot in office, store as well as dynamic charging while driving on the road. During dynamic charging while vehicle driving on the road the power transfer from the roadside electrical energy source to the battery of the electric vehicle through the transmitter and receiver coils which are integrated on the road surface and vehicle body, respectively. The efficiency of energy transfer between the transmitter and receiver coils depends on a number of factors including correct alignment between the transmitter and receiver coil, distance between the two coils, size of the coils and their dimension, coil material, number of turns, duty cycle, frequency, and so on. However, correct alignment of the coils is one of the main factors that affects mostly the efficiency of power transfer for dynamic charging as other parameters are fixed during the design phase. Therefore, the present disclosure involves technology to improve localization of CAEV for better automated control that ultimately improve correct alignment of the coils as well as path planning for improve charging efficiency.

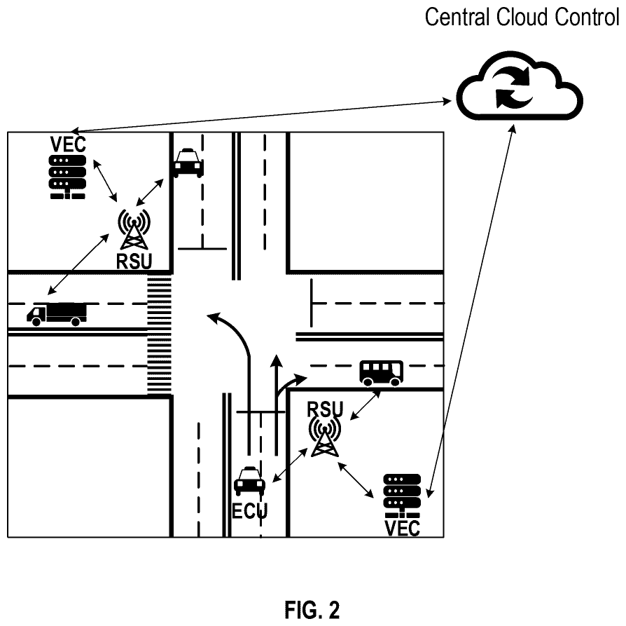

FIG. 2 illustrates a plurality of resources to process computation tasks of a CAEV. A CAEV uses different kinds of sensing techniques or sensors for realizing automated driving (AD) and/or ADAS applications. Commonly used sensors include mono camera, stereo camera, infrared camera, radar, lidar, laser, ultrasonic sensor, GPS, IMU, and so on. For any specific driver assistance system application or any specific level of automated driving, sensors are selected considering their advantages and disadvantages including range of motion, type of detection ability, power requirement, cost, amount of data generation, and so on. Generally, level-1 and/or level-2 automated vehicle functions (like adaptive cruise control—ACC) could be realized using a standalone sensor like stereo camera, or a combination of camera and radar. Multiple sensors are mostly required to realize high level of automated driving like level-3 to level-5. For fully automated vehicle like level-4 and level-5, it is essential to continuously monitoring the 360 degrees around the vehicle to avoid any obstacles and navigate safely which requires multiple sensors to work together. For fully automated driving or high level of ADAS applications, understanding accurate location of the vehicle on the road or map is highly important. Therefore, to pinpoint the actual location of the automated vehicle, sensor(s) information is processed real-time in localization algorithm and localization provides the accurate location of the vehicle on the map and or with respect to some static objects on map. However, as all sensors have limitations on certain scenarios including calibration issue, localization accuracy is one of the critical issues for automated vehicle. The charging rate information of CAEV during dynamic charging could be effectively utilized for accurate localization of the vehicle and the following sections explains the details of the proposed technology.

A CAEV is connected and shared its information with other vehicles, infrastructures, roadside units (RSU), cloud and/or vehicular edge controller (VEC) based connected vehicle data management platform using any of a different communication technology including conventional cellular networks (LTE, 5G), WIFI, dedicated short range communication (DSRC), cellular vehicle to everything (C V2X), and so on. CAEV generates data from its in-vehicle sensors as well as data collected through connectivity and these data need to process in real-time for realizing automated driving. High performance expensive processing units needed to process these huge data in real-time for automated vehicle. Therefore, to reduce the costs of the vehicle, technologies are available to allocate computational tasks effectively to the other common processing units which are located in cloud and VEC.

Processing units of other vehicles can also be used, however, three different types of processing units are considered in this proposed technique which works together to execute/process the necessary computation for automated vehicle. The example of FIG. 2 shows a schematic diagram that shows three processing units—(a) vehicle ECU (b) vehicle edge computing (VEC) and (c) central cloud. However, any number of processing units greater than or less than three processing units may be used. As shown in FIG. 2, ECUs are installed in the connected vehicle. Vehicular edge computing is a promising paradigm emerging recently in connected vehicle computing purposes where computing resources are located near the roadside to assist connected vehicles for processing the data. Central cloud-based computing is done using conventional cloud-based approaches where cloud infrastructure is generally located at remote site to assist connected vehicles for non-time critical application computing purposes. Since VEC resources are located at closer distance to the vehicles compared to the central cloud resources, execution of time critical safety and control applications are generally performed in VEC compared to the central cloud resources. It can be noted that the roadside units (RSU) as shown in FIG. 2 are used to communicate the vehicles and perform the computation task in VEC. In certain cases, RSU and VEC can be considered as one unit also to send/receive data to/from the connected vehicle as well as to process the data.

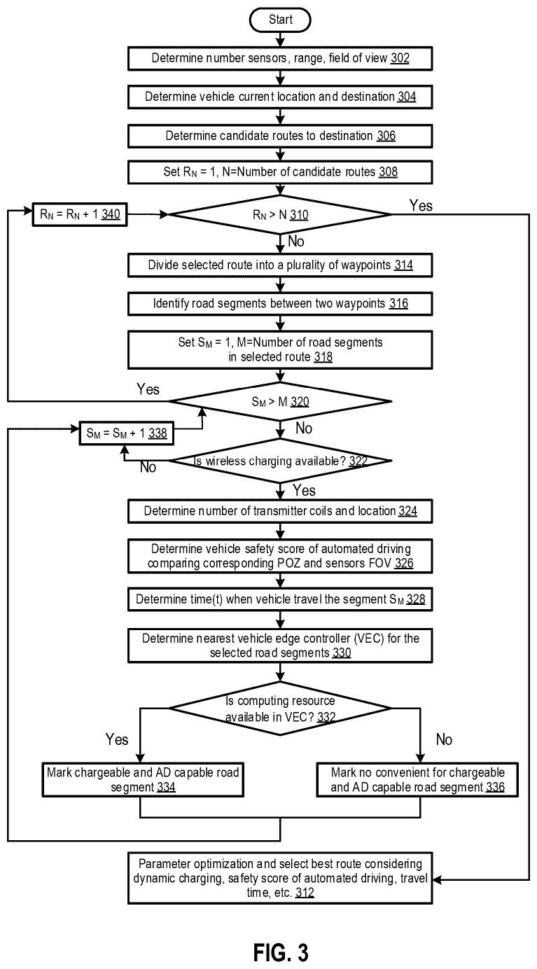

FIG. 3 illustrates a schematic diagram of a system architecture. Specifically, FIG. 3 illustrates a system architecture to find the best route considering dynamic charging and safety of a CAEV in which the system from 302 to 310 illustrates an example process for determining the number of candidate routes, the system from 314 to 320 illustrates an example process for determining the number of road segments in a selected route, the system at 322 determines if wireless charging is available, the system from 324 to 332 determines if computing resources are available in a VEC.

At the beginning of a trip, a CAEV shares information with the central cloud. For example, at 302, the CAEV, shares with the central cloud information related to the number of sensors, range, and field of view, ECU specifications of the CAEV. In addition, at 304, the CAEV shares with the central cloud information related to the current location of the vehicle, and the destination. Conventional cellular networks (LTE, 5G), WIFI, dedicated short range communication (DSRC), V2X, and other communication protocols can be used to share connected data with the vehicle. It can be noted that in case there is no central cloud the proposed approach can be executed within vehicle ECU and the VEC. Similarly, the proposed approach can also be executed using roadside cloud infrastructure and vehicle ECU in case of the absence of VEC. Once central cloud receives CAEV information, it will identify, at 306, the potential routes to the destination. At 308, the central cloud sets the R_{N} to a value of 1, where N is the number of candidate routes. At 310, the central cloud determines whether R_{N}>N. If R_{N} is greater than N, then the central cloud, at 312, performs parameter optimization and selects the best route considering dynamic charging, safety score of automated driving, travel time, and so on. If R_{N} is not greater then N, then the central cloud proceeds to 314.

At 314, the central cloud divides the selected route into several road segments which are the distance between two waypoints/nodes. Road's waypoints or nodes are defined based on the High-Definition Map or Standard Map as stored in the database. Note that the length of road segments may vary from a few centimeters to several hundreds of meters. At 316, the central cloud identifies road segments between two waypoints. At 318, the central cloud sets S_{M} to a value of 1 where M is the number of road segments in the selected route. At 320, the central cloud determines whether S_{M}>M. If S_{M} is greater than M, then the central cloud, at 340, increments the value of R_{N} such that R_{N}=R_{N}+1. If S_{M} is not greater than M, then the central cloud proceeds to 322.

For every segment, the central cloud determines, at 322, whether inductive wireless charging is possible or not. If wireless charging is not possible, then the central cloud, at 338, increments the value of S_{M} such that S_{M}=S_{M}+1. If wireless charging is possible, then the central cloud, at 324 determines the number of transmitter coils installed on the road of the corresponding segment and the location. One of the objectives of central cloud-based data management platform is to identify the best routes that will allow charging of battery while driving on the road along with automated driving capability in order to ensure vehicle reached the destination with maximum charge amount together with safety of automated driving. Thus, if the road segment does not have any transmitter coil, system will check the next segment. If the road segment has integrated transmitter coil, data management platform determines number of transmitter coil and their location (with respect to the map data) using the database. Note that, data management platform receives this data from Government or local department of transportation database. At 326, the central cloud platform determines safety score of the corresponding road segment for automated driving ability of the vehicle comparing precautionary observation zone (POZ) and field of view (FOV) of the in-vehicle sensors. Considering CAEV's current location, real-time traffic data from map service provider, historic traffic data, and so on, the central cloud, at 328, determines the time when the CAEV will travel that road segment. At 330, the central cloud determines the nearest VEC of the selected road segment(s). At 332, the central cloud determines whether computing resources are available at the VEC. Path planning of CAEV during dynamic charging while driving on the road need to be done in real-time. A central cloud-based data management platform cannot be able to support CAEV real-time for path planning and control. Therefore, a road segment with integrated transmitter coil and roadside VEC considered as chargeable and AD capable road segment, at 334. Otherwise, it will not be considered as a suitable road segment, at 336. The central cloud then proceeds to increment the value of S_{M} such that S_{M}=S_{M}+1. The cloud-based data management platform performs this analysis for all of the possible road segments for all candidate routes and finally optimize battery charging, vehicle dynamics, AD capable safety score, travel time, and so on, to select the best route for the CAEV.

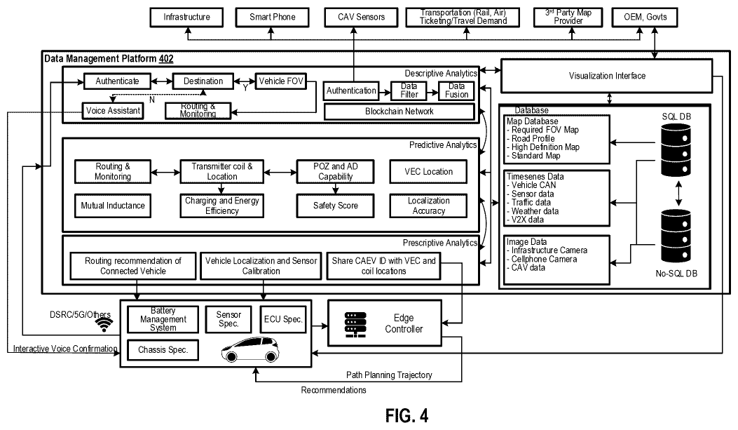

FIG. 4 illustrates a schematic drawing of a connected vehicle data management platform. Specifically, FIG. 4 shows a CAEV is connected with a data exchange and analytics platform (e.g., FALCON®). At the beginning of a trip, a CAEV shares its onboard sensors specifications, powertrain, destination, vehicle data, and so on, with the platform using defined or standard data format. The vehicle can exchange information with the data analytics platform directly using any available communication protocols or through roadside units (RSU) or other wireless communication devices. The platform receives the data from different sources such as vehicles, infrastructure sensors, cellphone, service providers (e.g., weather, traffic, and so on), transportation agencies, insurance providers, fleet companies, and so on. The platform processes the received data to derives value for end users by using different artificial intelligent (AI) modules categorized in different analytics layers, including descriptive, predictive, and prescriptive analytics as well as consists of database and data visualization interface. Further, the platform can share vehicle data to other third parties such as OEMs and allows reception of data from third parties (e.g., map providers) into the platform using different modules.

As shown in FIG. 4, at the beginning of a trip a CAEV sends vehicle information which may be related to CAEV capabilities or supported features/services. For example, the CAEV sends encrypted on board vehicle sensor specification, ECU, powertrain, and chassis specification, and so on. to the platform using broadcasting protocol such as, but not limited to MQTT, UDP, and the like. The encrypted vehicle information is first processed in the descriptive analytics modules. Descriptive analytics layer includes different modules including data decryption, data cleaning, data authentication, data parsing, data filtering, data fusion, data hashing, and so on. to thoroughly examine the data incoming from the CAEV as well as from the other sources. As shown in FIG. 4, the data authentication module confirms the data from the correct CAEV and validates the integrity of data. However, in some instances, other data analytics module may also be used for descriptive analytics layer such as data decryption, data parsing, and so on. A Data Decryption module performs decrypting message sent from vehicle so that data is executable and support for next analytic activities. Data Parsing module in Descriptive layer is to parse incoming message from vehicle to JSON format. JSON format is an example of a format that may be used, and the disclosure is not intended to be limited to JSON format, such that other formats may be used. The process of detecting and correcting any corrupt messages sent from the vehicle is performed in Data Cleaning module. Data Filtering and Data Fusion modules are used to preprocess the data transmitted from the vehicle and update the database accordingly. Infrastructure and/or other (connected vehicles) sensors data are also received in the platform descriptive analytics layer. Blockchain networks are used to exchange data with all 3rd party service providers.

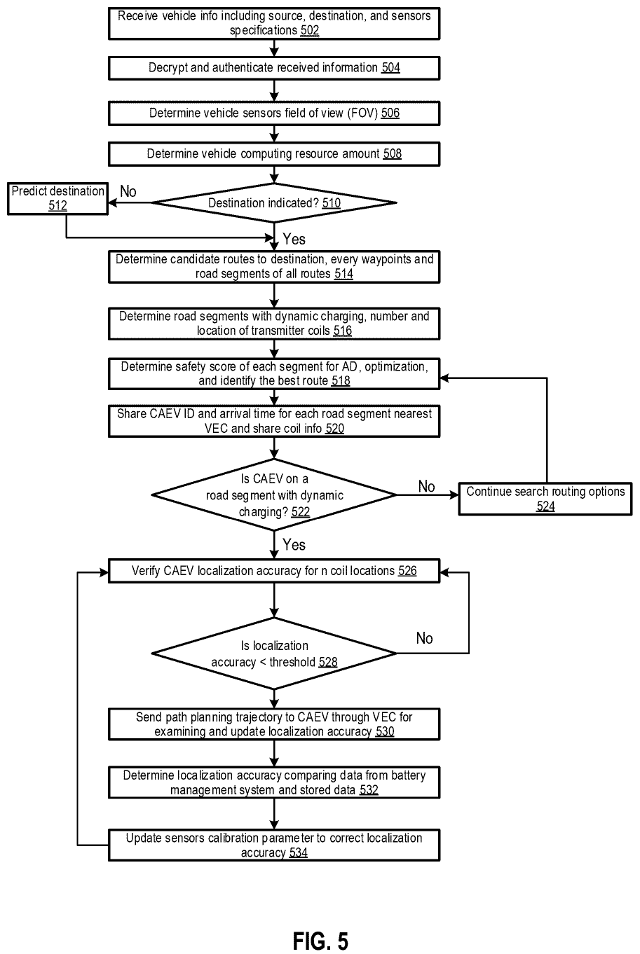

FIG. 5 illustrates an example flow for the data management platform. Specifically, FIG. 5 shows a flowchart of the tasks executed in the central cloud-based data management platform (e.g., FALCON®). At the beginning of a trip a CAEV sends vehicle information to the data management platform. For example, at 502, the platform receives vehicle information which may include source, destination, or sensor specifications of the vehicle, as shown in connection with the example implementation of FIG. 4. At 504, the platform decrypts and authenticates the information received from the vehicle. As shown in FIG. 4, the authentication module within the descriptive analytics layer of the platform decrypts the incoming vehicle data and establishes identification of the vehicle and driver by using cryptographic hash algorithms such as MDS, SHA-1, SHA256, or the like. If the vehicle destination is available in the decrypted vehicle data, then the routing and monitoring module in descriptive analytics accepts inputs of vehicle location, destination, map, traffic and weather data and determines potential routes for the vehicle to reach its destination. At 506, the platform may determine vehicle sensors field of view. For example, the vehicle sensors specification may be provided to the “Vehicle FOV” module to identify the Field of View of the CAEV which is finally passed to the “Routing & Monitoring” module within the predictive analytics layer of the platform.

At 510, the platform may determine whether the information received from the vehicle indicates a destination. In instances where the destination of the connected vehicle is not specified by the system/driver, the platform, at 512, may predict the destination. The prediction of the destination may be performed by the “Routing & Monitoring” module in predictive layer, as shown in connection with FIG. 4. The “Routing & Monitoring” module may predict the connected vehicle's destination using an AI model based at least on one of a driver/passenger/vehicle profile, historic trip data, time-of-day, and so on. that stored in the database. The predicted destination is passed to AI based “Voice Assistance” module which sends interactive voice request to driver/passenger for obtaining confirmation of predicted destination. Voice assistant is part of the User Interface (UI) that includes three submodules: Speech-2-Text (STT), Conversation bot, and Text-2-Speech. In some instances, the UE may include more than three or less than three submodules, and the disclosure is not intended to be limited to the examples disclosed herein. In instances where the automated vehicle driver/passenger/system confirmed the destination, confirmation is sent back to the ‘Routing & Monitoring’ module in predictive analytics layer. Otherwise, the platform decides the destination based on the destination predicted by “Routing & Monitoring” module in predictive analytics layer. This module gets input of real-time traffic and confirmed destination inputs for route prediction. The real-time traffic is updated using time loop that executes at fixed time interval and obtains traffic data from 3rd party, this traffic data is ingested in the database and sent to “Routing & Monitoring” module. In instances where the destination of the connected vehicle is specified by the system/driver, the platform may proceed to 514. Once the destination has been finalized either by descriptive or predictive “Routing & Monitoring” module, the platform, at 514 may determine candidate routes to the destination, as well as every waypoint and/or road segments of all candidate routes. For example, potential routes from start to destination may be calculated in the “Routing & Monitoring” module using a routing engine, as shown in connection with FIG. 4. Calculated potential routes are subsequently send to the “Transmitter Coil & Location” and “POZ (Precautionary Observation Zone) and AD (Automated Driving) Capability” modules in the predictive layer.

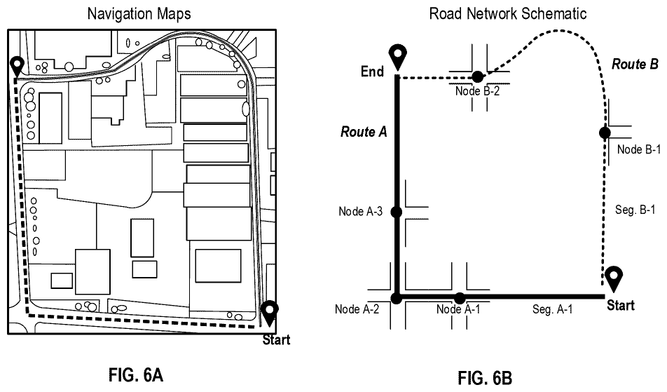

At 516, the platform may determine road segments with dynamic charging, along with the number and location of transmitter coils. As mentioned above, “Routing and Monitoring” module decides the different routes from source to destination of CAEV. Each route is further divided into several road segments which are the distance between two waypoints/nodes. Road's waypoints or nodes are defined based on the High-Definition Map or Standard Map as shown in the Database of FIG. 4. Each route waypoints/nodes as well as the road segments are defined in “Routing and Monitoring” module and may be stored in the database. FIGS. 6A and 6B show an example where there are two potential routes available from start to end/destination. Each route is divided into several road segments which are the distance between two nodes. The length of each road segment depends on the types of roads. Road segments can vary from few meters to several hundred meters. Once the platform identifies the destination of a CAEV as well as calculated waypoints and road segments for each of the candidate routes, “Transmitter Coil & Location” module of the predictive analytics layer calculates the number of transmitter coils integrated on that road segments for dynamic charging and their location on the map, as shown for example in FIG. 4.

At 518, the platform may determine a safety score of each segment for AD, optimization, and identification of the best route. For example, once the platform identifies dynamic charging transmitter coils number and locations on the road segments, the platform determines the safety score of that road segment comparing precautionary observation zone (POZ) and field of view (FOV) of the CAEV sensors, as shown in connection with FIG. 4. Precautionary Observation Zone (POZ) of a road segment can be defined as the area that a vehicle may monitor on that road segment for fully automated driving to ensure its safety. The platform database may include the POZ for all the potential routes. The safety score indicates a percentage of POZ that can be covered by vehicle sensor FOV. For automated driving, it is desirable for the vehicle FOV to cover POZ. In instances where the vehicle FOV does not cover the POZ for a road segment, the platform identifies the time when the vehicle crosses the road segment and a corresponding nearest VEC to support the vehicle to realize automated driving for that road segment. At this stage, the platform defines the areas (Region-X) where the vehicle on board sensor is unable to monitor and identifies such areas where support is provided to assist in the monitoring of such areas. Once safety score of each road segments are calculated, an optimization function works next to determine the best route of the CAEV considering dynamic charging availability (e.g., vehicle having a maximum charge after reaching the destination), safety score for realizing automated driving, travel time, road condition (comfort and vehicle dynamics), and so on.

At 520, the platform shares the CAEV ID and arrival time for each road segment to the nearest VEC and the coil information. For example, after selecting the best route, the platform shares the vehicle ID and approximate arrival time with the VEC of corresponding road segments of the selected routes. The sharing of the information with the VEC may be performed by the prescriptive analytics layer of the platform, as shown in connection with FIG. 4. A roadside vehicular edge controller (VEC) receives the CAEV details and tentative arrival time from the platform as explained above and as shown in connection with any of FIGS. 2-5. The VEC receives information from the platform using high speed LAN, ethernet, cellular communication, and/or any other conventional communication protocol.

At 522, the platform may determine whether the CAEV is on a road segment with dynamic charging. In some instances, the platform may continue to search for the best route until the CAEV reaches its destination. For example, in instances where the CAEV is on a road segment that does not have dynamic charging, the platform, at 524, may continue to search routing options. In instances where the CAEV is on a road segment that does have dynamic charging, the platform, at 526, may verify CAEV localization accuracy for n coil locations. At 528, the platform may determine whether localization accuracy is less than a threshold. In instances where the localization accuracy is less than a threshold, the platform may revert to 526 and verify the CAEV localization accuracy for the n coil locations. In instances where the localization accuracy is not less than the threshold, or exceeds the threshold, the process may proceed to 530. The flow process from 522 to 528 may be performed by one or more modules within the predictive analytics layer of the platform, as shown in connection with FIG. 4.

At 530, the path planning trajectory is sent to the CAEV for examining and updating localization accuracy. For example, the path planning trajectory may be sent to the CAEV through the VEC for examining and updating the localization accuracy, as shown in connection with any of FIG. 2, 4, or 6. The path planning trajectory may be sent to the CAEV from the VEC by way of the RSU. The transmitter coil's locations (e.g., integrated on the road segment) are known by VEC and/or the platform. The location of the receiver coil that is installed in the CAEV is also known by VEC and/or the platform. Thereby, path planning trajectory of the CAEV is determined in such a way so that while driving CAEV's receiver coil completely aligned with the transmitter coil. Lateral and longitudinal misalignment may reduce the wireless power transmission efficiency. However, since vehicle will be moving, longitudinal misalignment may not be considered, and only lateral misalignment is considered. Therefore, the path planning trajectory will ensure that the vehicle receiver coil will be aligned in lateral direction when CAEV moves on the transmitter coil. The VEC may also send a recommendation to the vehicle for the best speed considering traffic on the road segment as well to ensure maximum charging efficiency.

At 532, the CAEV may determine localization accuracy by comparing data from the battery management system and stored data, as shown in connection with any of FIG. 2 or 4. The CAEV may determine the localization accuracy in response to receiving the path planning trajectory. At 534, the CAEV may update sensor calibration parameters to correct localization accuracy, as shown in connection with FIG. 4.

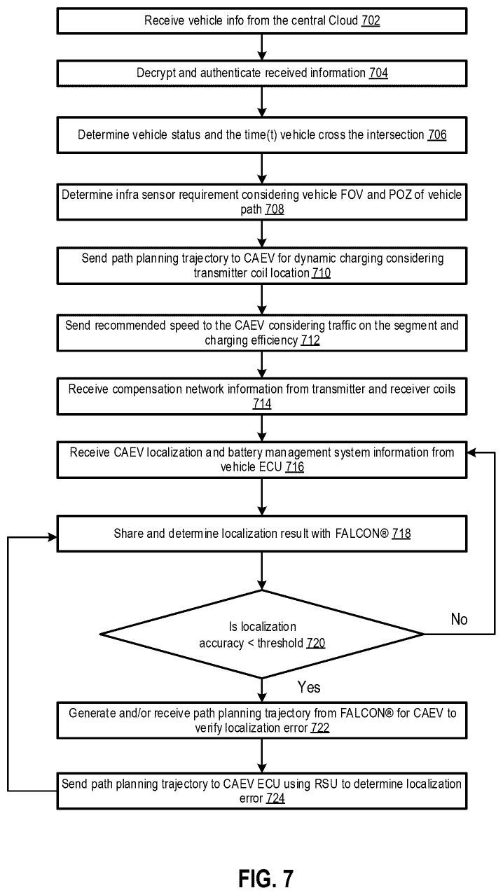

FIG. 7 illustrates an example flow for vehicular edge computing (VEC). Specifically, FIG. 7 shows a flowchart that describes an example implementation of workflow in the VEC, as described in connection with any of FIGS. 2-5. In some aspects, the data processing may also be executed by the VEC instead of the remote cloud-based platform.

At 702, the VEC may receive vehicle information from the platform. For example, the VEC may receive the vehicle information from the central cloud, as shown in connection with any of FIG. 2, 4, or 5. Once VEC receives encrypted vehicle information from the platform, the VEC, at 704, may decrypt and authenticate the received vehicle information. For example, the authentication module in the VEC decrypts the incoming data and establishes identification of the vehicle using cryptographic hash algorithms such as MDS, SHA-1, SHA256 and so forth. In response to decrypting and authenticating the received information, the VEC, at 706, determines the vehicle status and the time (t) that the vehicle crosses an intersection. The VEC identifies the time (t) when the vehicle crosses the nearest road segments as well as determines vehicles status whether the vehicle is resource available vehicle (RAV) or resource demand vehicle (RDV), as shown in connection with any of FIG. 2, 4, 5, or 6.

At 708, the VEC may determine infra sensor requirements in consideration of the FOV of the vehicle and/or the POZ of the vehicle path, as shown in connection with any of FIG. 2, 4, 5, or 6. In instances where the CAEV is an RDV, the VEC may provide support to the CAEV by providing computing resource as well as road obstacle information and road information from infrastructure sensors for the segment where CAEV's in-vehicle sensors FOV are not able to cover the POZ of that segment. In instances where the CAEV is an RAV, the VEC may refrain from providing support to the CAEV for automated driving functionality. Once the CAEV arrives within the working range of the VEC, it detects CAEV presence using RSU information through C-V2X, DSRC, or other communication protocol.

At 710, the path planning trajectory is sent to the CAEV for dynamic charging in consideration of transmitter coil locations. For example, the path planning trajectory may be sent to the CAEV through the VEC for dynamic charging in consideration of the transmitter coil locations, as shown in connection with any of FIG. 2, 4, 5 or 6. The path planning trajectory may be sent to the CAEV from the VEC by way of the RSU. The transmitter coil's locations (e.g., integrated on the road segment) are known by VEC and/or the platform. The location of the receiver coil that is installed in the CAEV is also known by VEC and/or the platform. Thereby, path planning trajectory of the CAEV is determined in such a way so that while driving CAEV's receiver coil completely aligned with the transmitter coil. Lateral and longitudinal misalignment may reduce the wireless power transmission efficiency. However, since vehicle will be moving, longitudinal misalignment may not be considered, and only lateral misalignment is considered. Therefore, the path planning trajectory will ensure that the vehicle receiver coil will be aligned in lateral direction when CAEV moves on the transmitter coil. The VEC, at 712, may also send a recommended speed to the CAEV in consideration of traffic on the segment and/or charging efficiency. For example, the VEC may provide a recommendation to the vehicle for the best speed considering traffic on the road segment as well to ensure maximum charging efficiency, as shown in connection with FIG. 5.

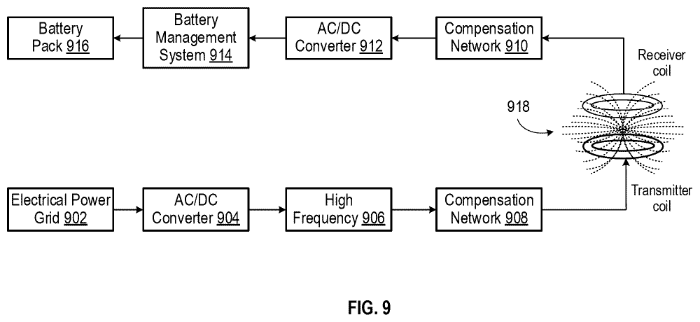

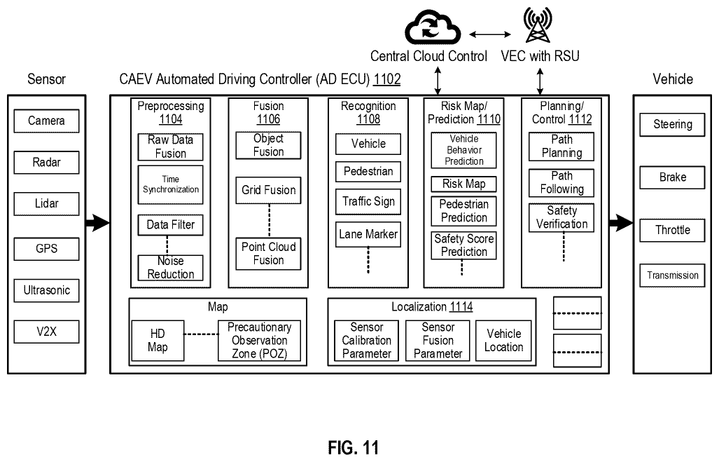

At 714, the VEC may receive compensation network information from the transmitter and receiver coils, as shown in connection with FIG. 9. At 716, the VEC may receive CAEV localization and battery management system information from the vehicle. For example, the VEC may receive the CAEV localization and the battery management system information from the ECU of the vehicle, as shown in connection with any of FIG. 4 or 9. Once the VEC receives the compensation network signal, the VEC identifies the CAEV's location with respect to a specific transmitter coil on the road. At 716, the VEC may receive CAEV localization and battery management system (BMS) information from the vehicle ECU. For example, to identify the CAEV's location on the road, the VEC receives inductance or current from the vehicle's BMS, as shown in connection with any of FIG. 4 or 9. At 718, the VEC may share and determine the localization result with the platform, as shown in connection with any of FIG. 2 or 11. At 720, the VEC may determine whether localization accuracy is less than a threshold. If the localization accuracy is not less than the threshold, then the flow process may repeat at 716, until the localization accuracy is less than the threshold. If the localization accuracy is less than the threshold, then the flow process may proceed to 722. At 722, the VEC may generate and/or receive the path planning trajectory from the platform for the CAEV to verify localization error, as shown in connection with any of FIGS. 2, 4, 5, 11. At 724, the VEC may send the path planning trajectory to the CAEV to determine localization error. For example, the VEC may send the path planning trajectory to the ECU of the CAEV via the RSU to determine the localization error.

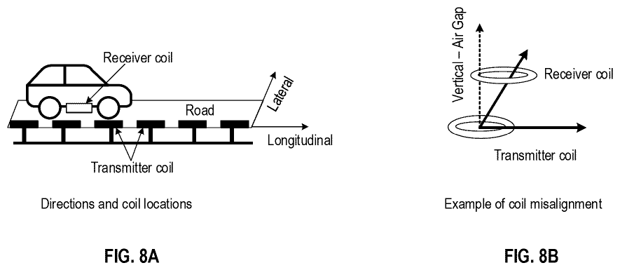

FIG. 8A shows an example of transmitter and receiver coils used in dynamic charging, FIG. 8B shows an example of coil misalignment in the lateral direction. There are many different coil structures in wireless EV charging including circular, circular rectangle, bipolar, double-D, and so on. However, as circular coil shape provides efficiency power transmission, circular coils are shown in FIGS. 8A, 8B, and 9 as example coils. As discussed herein, a receiver coil may be within a vehicle and may receive an inductance charge as it passes over a transmitter coil which may be within a road or surface that the vehicle is traveling on. As shown in FIG. 8A, a vertical air gap is present between the transmitter coil and the receiver coil. Efficiency of the wireless charging is based in part on the alignment between the transmitter coil and the receiver coil. For example, as shown in FIG. 8B, misalignment between the transmitter coil and the receiver coil may occur which may lead to less than efficient wireless charging.

FIG. 9 illustrates an example of an induction wireless charging system. Specifically, FIG. 9 shows a schematic diagram of induction wireless charging between a transmitter coil and a receiver coil. As shown in FIG. 9, electrical energy from power grid 902 is first converted into direct current through AC/DC converter 904. The power is converted into high frequency 906 in next step through a DC/AC converter. To realize maximum power transmission, compensation network 908, 910 is used in both of the transmitter coil and the receiver coil. There are different kinds of compensation topology that may be used, such as but not limited to series-series, parallel-parallel, series-parallel, and parallel-series. Any of the available compensation technique could be used herein. In some instances, capacitors are used in both of the transmitter and receiver coils to make the compensation network that helps to understand the location of the receiver coil with respect to the transmitter coil. This compensation network 908, 910 helps to transfer the power by resonating the transmitter coil and the receiver coil. The high frequency AC current creates magnetic field in the transmitter coil which flows in the receiver coil as shown in FIG. 9 and ultimately generates AC current in the receiver coil. This AC current is then converted into DC current by the AC/DC converter 912 and is provided to the vehicle's Battery Management System (BMS) 914. Based on the CAEV's battery state of charge (SOC) and state of health (SOH), the BMS provides the optimum current to the battery pack 916 for efficient charging.

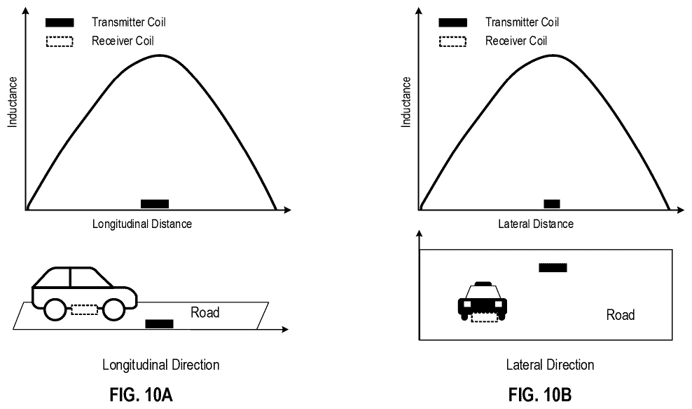

As shown in FIG. 7, once the VEC receives the compensation network signal through communication channels, the VEC identifies the CAEV's location with respect to a specific transmitter coil on the road. To identify the CAEV's location on the road, VEC receives inductance and/or current from the vehicle BMS. FIG. 10A shows a schematic diagram of mutual inductance variance of the receiver coil with respect to the lateral distance from the transmitter coil, while FIG. 10B shows a schematic diagram of mutual inductance variance of the receiver coil with respect to the longitudinal distance from the transmitter coil. Mutual inductance of the receiver coil is used to calculate the amount of power or current transferred to the vehicle. Mutual inductance varies for different turn on the coil, and in the examples discussed herein, the coil may comprise an innermost turn. However, the coil may comprise many different turns and is not intended to be limited to the examples presented herein. Instead of mutual inductance the amount of current flowed to the battery can also be considered to calculate the lateral and longitudinal distance of the receiver coil, e.g., the CAEV with respect to the transmitter coil mounted on the road. The mutual inductance module in the predictive analytics layer of the platform, as shown for example in FIG. 4, may calculate the mutual inductance versus lateral and longitudinal locations of the vehicle for each road segments that contains a transmitter coil. Therefore, the VEC calculates the location of the vehicle based on the data received from the platform and BSM of CAEV.

Once the VEC calculates the location of the vehicle (e.g., using BMS and the platform received data), the VEC may also receive the location information from CAEV's AD/ADAS ECU. As shown in FIGS. 10A and 10B, mutual inductance of received coil varies due to misalignment in both of longitudinal and lateral direction. It could be noted that as the VEC sends the path planning trajectory to the CAEV at the beginning of any road segments, thus it is expected that the mutual inductance from the CAEV will always be at its highest value once the vehicle moves over the 1ₛₜ transmitter coil of the corresponding road segment. Therefore, once the VEC receives compensation network signal from the 1ₛₜ transmitter coil of the road segment, the VEC starts to record location data of the vehicle (e.g., using BMS and the platform), mutual inductance from the BMS, as well as location information of vehicle calculated by the CAEV's ECU using in-vehicles sensor data. Recorded data should be synchronized in view of known or expected communication latency time. Once the VEC identifies completion of data for a cycle (e.g., start of increase inductance—maximum inductance—decrease to zero) as shown in FIG. 10A or 10B, the VEC starts verifying the localization accuracy considering the following four scenarios:

(1) Case-1: No localization error calculated by the vehicle ECU using in-vehicles sensors data. This scenario indicates that the vehicle ECU calculated localization information has no error either in lateral or longitudinal directions. In this case, maximum mutual inductance calculated by the VEC will be similar (or within a threshold limit) to the maximum mutual inductance shared by the platform. Moreover, in this case the location where maximum mutual inductance observed is matched (or within a threshold limit) with the location information received from the vehicle ECU.

(2) Case-2: The maximum mutual inductance value calculated by the VEC is similar (or within a threshold limit) to the maximum mutual inductance shared by the platform. However, the location where maximum mutual inductance observed does not match (or within a threshold limit) with the location information received from the vehicle ECU. In such instances, there is no lateral localization error in lateral direction as calculated by the vehicle ECU and there is only longitudinal location error that cause this mismatch. Once this case would be observed, the VEC will send the localization accuracy error signal to the platform. Consecutively, the platform calculates localization error and updates sensors calibration parameters accordingly to avoid this longitudinal localization error. For example, in instances where the CAEV's in-vehicle sensor includes only one or multiple cameras for automated driving, the platform updates the intrinsic and extrinsic parameters of the camera in order to remove the longitudinal localization error. In instances of a sensor fusion system, the platform may add threshold values at the fusion output to minimize this longitudinal localization error.

(3) Case-3: The maximum mutual inductance value calculated by the VEC is beyond the limit to the maximum mutual inductance shared by the platform. However, the location where maximum mutual inductance observed match (or within a threshold limit) with the location information received from the vehicle ECU. In this case, there is no longitudinal localization error calculated by the vehicle ECU and there is only lateral direction error that cause this mismatch. Once this case would be observed, the VEC will send the localization accuracy error signal to the platform. Consecutively, the platform calculates localization error and updates sensors calibration parameters accordingly to avoid this localization error due to lateral position calculation error. For example, in case the CAEV's in-vehicle sensor includes only one or multiple cameras for automated driving, the platform updates the intrinsic and extrinsic parameters of the camera in order to remove the lateral localization error. In instances of a sensor fusion system, the platform may add threshold values at the fusion output to minimize this localization error.

(4) Case-4: The maximum mutual inductance value calculated by the VEC is beyond the limit to the maximum mutual inductance shared by the platform. Moreover, the location where maximum mutual inductance observed does not match (or within a threshold limit) with the location information received from the vehicle ECU. Once this case would be observed, the VEC will send the localization accuracy error signal to the platform. For this case, lateral localization error will be handled first. Based on the road segments properties (number of transmitter coils and their distances, and so on.) the platform sends the updated path planning trajectory to the VEC that is shared with the CAEV. The platform may add a threshold value with lateral position only to check how much error is there. For example, once this case observed, the platform may add a positive threshold value (+Δx) with the lateral path value. Once the cycle completed, e.g., the vehicle passes over the next transmitter coil, the VEC compares the maximum mutual inductance value with that of calculated for the previous transmitter coil—(a) If the mutual inductance increase (e.g., moves closer to the maximum inductance shared by platform but does not reach within the threshold limit), the VEC continue increment positive threshold value with lateral direction until it matches with the maximum inductance shared by the platform. (b) If the mutual inductance decreased (e.g., moves far away to the maximum inductance shared by the platform compared to the previous coil location value), the VEC adds a negative threshold value (−Δx) with the lateral path value and continues incrementing negative threshold value with lateral direction until it matches (or within a threshold limit) with the maximum inductance shared by the platform. Once the VEC calculated maximum inductance will match with the value shared by the platform, it could be confirmed that there is no more lateral direction position error calculated by the vehicle ECU. The total threshold value added/subtracted during the previous steps may be calculated by the platform. Consecutively, as there is no lateral direction error anymore, the longitudinal direction localization error will be calculated as described in Case-2. The platform may update the sensors calibration parameters or update the threshold of fusion algorithm based on the threshold value added.

The process of validating the accuracy of localization which is calculated by the vehicle ECU using onboard sensor data will continue until onboard vehicle sensors and ECU results in a correct localization. This process may continue even as the CAEV passes one road segment and starts traversing on the next segment. The VEC, CAEV ECU, and the platform may share information with each other for effective updating of localization parameters. The platform may calculate and store the inductance and/or current profile, as shown in FIGS. 10A, 10B, for the coils of every road segment offline and store the data in a map database layer. The platform may utilize the CAEV's receiver coil information and transmitter coil specification data from road authorities to calculate the inductance (and/or current) profile.

FIG. 11 illustrates an example of a control architecture for an automated driving system. Specifically, FIG. 11 shows a schematic diagram of control architecture for automated driving system of the CAEV. An automated driving controller 1102 includes different functions including data processing 1104, fusion 1106, perception, cognition 1108, behavior prediction/risk map 1110, planning/control 1112, and so on. Each of these functions also consist of sub functions as shown in the respective blocks. Sensor's calibration parameters and sensor fusion parameters which are shown in the Localization 1114 block may also be used in preprocessing, fusion, and other blocks and specifically shown in localization blocks for ease of understanding. Once the platform (e.g., central cloud control) identifies the localization error calculated by the AD ECU of the CAEV, the platform updates the calibration parameter and sensor fusion parameters to minimize the localization. These updated parameters are consecutively also used in preprocessing, fusion, and other blocks. The AD ECU of the CAEV may utilize the recognition results/features for fusion and identify the obstacles, road features, road anomalies, and so on, which may be use for the vehicle control command. The VEC and the CAEV AD ECU may share functions (fusion, recognition, risk map prediction, localization, and so on) or subfunctions utilized to calculate the vehicle control signal based at least on the computing requirements and available resources.

The example implementations described herein may provide significant benefits for the current and future connected automated electric vehicle (CAEV) ecosystem over the related art. For example, the example implementations provide technique for path planning and localization of CAEVs during dynamic charging that will ensure efficient charging of EV battery and high level of automated driving by avoiding localization error, respectively. Electric vehicles (EV) have gained significant momentum during the last decades in order to realize sustainable society and resilient transportation systems. However, range anxiety, battery life and realizing high level of automated driving are still major challenges for CAEVs. Thus, the example implementations may bring significant benefits for connected electric vehicle applications as well as to improve and expand the functionalities of connected mobility platforms, sensors, edge controllers, and AD electronic control unit (ECU). The example implementations may bring significant benefits to design solutions for realizing safe and efficient EV using connected vehicle data management platform. Moreover, the example implementations may also be utilized to improve the functionalities of next generation AD ECUs. Furthermore, the example implementations may also be effectively applied for the controller designed for edge computing devices.

In the following routing example, as discussed additionally below, for a first route and a second route, a data analytics platform may execute the POZ determination process in the analytics layer to determine the POZs for each segment of each route. The vehicle sensor FOV may be calculated by the data analytics platform based on the vehicle onboard sensor configuration information received by the data analytics platform for the vehicle.

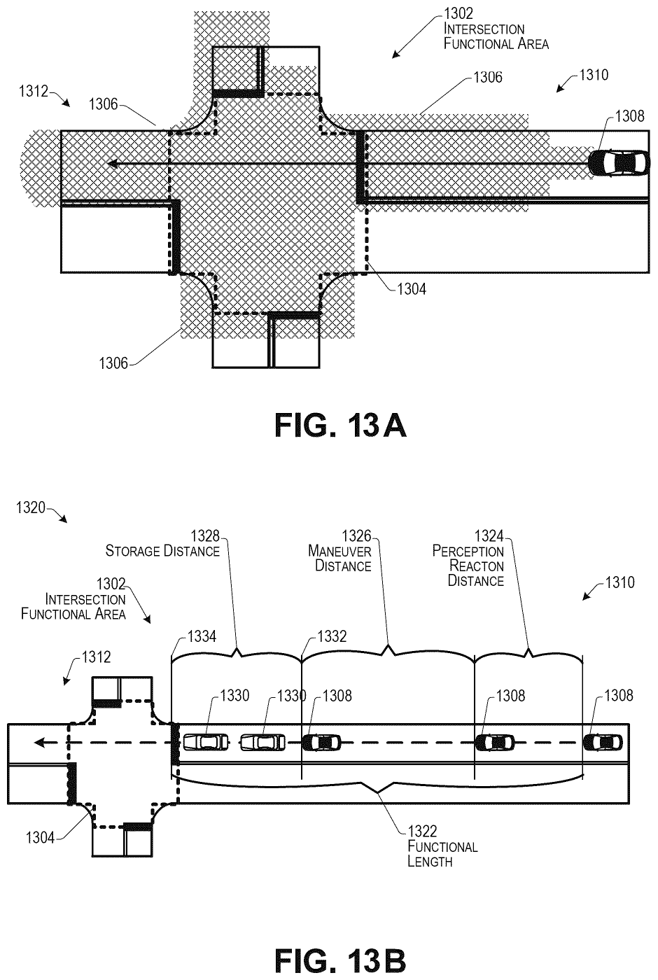

FIGS. 13A and 13B illustrate examples of intersections according to some implementations. FIG. 13A illustrates an example intersection 1300 according to some implementations. The intersection 1300 includes an intersection functional area 1302 indicated by cross hatching. The intersection functional area 1302 may include the crosshatched region that includes both an intersection physical area 1304 of the intersection (indicated by dashed line), and the additional areas 1306 outside of the intersection physical area 1304 in which a vehicle 1308 may maneuver. Thus, the intersection physical area 1304 may correspond to the fixed area within the four corners of the intersection 1300. On the other hand, the overall functional area 1302 may be variable and may include an upstream portion 1310 and a downstream portion 1312 as shown in FIG. 13B.

FIG. 13B illustrates an example intersection 1320 according to some implementations. As mentioned above, contrary to the fixed physical area 1304 of the intersection 1320, the intersection functional area 1302 is variable and includes both upstream portion 1310 and downstream portion 1312 in addition to the physical area 1304. The upstream area 1310 of the intersection functional area 1302 includes a functional length 1322. The functional length 1322 may be divided into several portions, such as when a vehicle 1308 approaches the intersection 1320 and during which the vehicle 1308 decelerates and comes to a complete stop. These portions include a perception reaction distance 1324 and a maneuver distance 1326. In addition, the functional length 1322 may include a storage distance 1328, which may be a portion of the intersection functional area 1302 in which other vehicles 1330 are queued.

Realizing safety at intersections may be accorded a high priority as accidents mostly happen at intersections. At the intersection, a human driver may understand where to make the lane changes, when and how to read the traffic light, location to stop, where to watch before making a turn, when and speed to make the turn, etc. An automated vehicle should have the ability to follow the sequential steps and observe the proper region to make human-like decisions. Thus, an automated vehicle should understand the different regions at intersections, such as those specified by government, local authorities, etc., and perform the same action for each region as a human driver would. The intersection functional area calculation may depend on the road speed limit, location, type of road, etc. which may be defined by designated authorities in each country. In the USA, according to the AASHTO (American Association of State Highway and Transportation Officials) intersection functional length (F) is the sum of stopping sight distance (S) plus the storage length distance (Q) as shown in EQ(1). In case there is no traffic, storage length (Q) becomes zero and intersection functional area becomes the stopping sight distance. The stopping sight distance is the combination of the distances traveled by a vehicle during two phases to stop the vehicle, i.e., a first phase is the perception reaction distance 1324 traveled during perception reaction time and the second phase is the maneuver distance 1326 traveled during a maneuver time:

F=S+Q EQ(1)

S=(1.47*V*t)+1.075*(V²/a) EQ(2)

where,
F=Intersection functional length
S=Stopping sight distance
Q=Storage or queue length
V=Design speed (mph)
t=Perception reaction time (2.5 Sec)
a=Deceleration rate (within 11 to 15 ft/sec², e.g., 11.2 ft/sec²).

The first part of EQ(2) indicates the distance covered during the perception reaction time during which the driver traverses the perception reaction distance 1326, realizes that a decision is needed, and decides what kind of maneuver is appropriate. The perception reaction time may typically be about 2.5 seconds, which includes about 1.5 seconds for perception and about 1.0 seconds for reaction. The second part of EQ(2) indicates the distance traveled by the driver during the maneuver distance for decelerating the vehicle and coming to a complete stop, e.g., at 1332 when there are other cars 1303 in the storage distance 1328, or at 1334 when there are no other cars in the storage distance 1328.

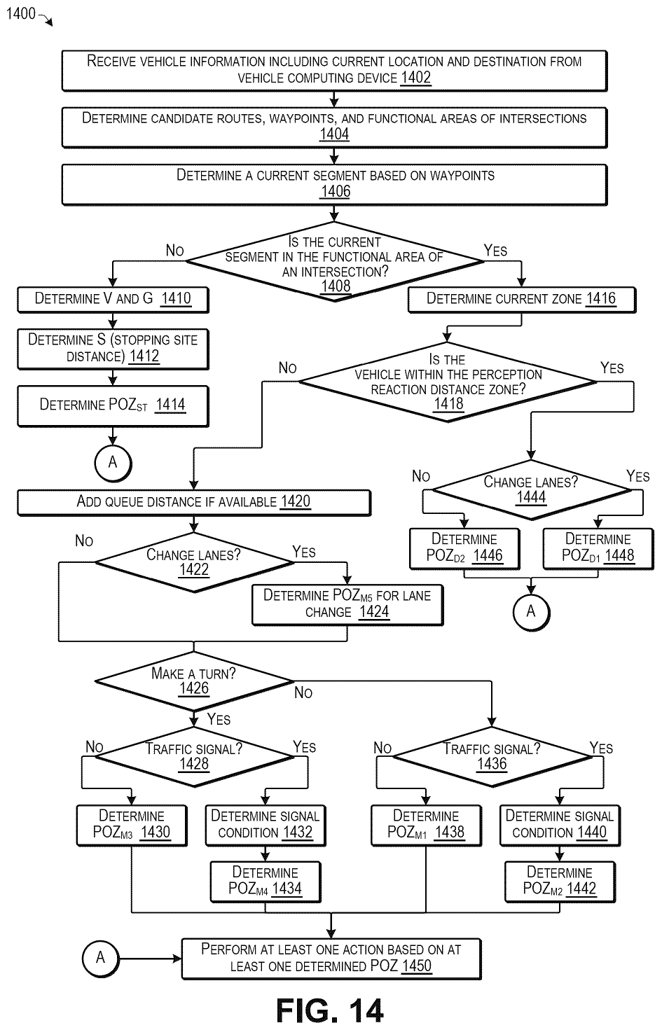

FIG. 14 is a flow diagram illustrating an example process 1400 for determining POZs for various different criteria according to some implementations. In some examples, the process 1400 may be executed by the system 100 discussed above. For example, the process 1400 may be executed by the data analytics platform, such as the service computing device(s) executing the navigation information program in some examples. Once a connected vehicle shares its current location and destination, the corresponding road segments may be calculated by the data analytics platform for all the candidate routes to the destination location. The road segments may be divided into two categories: (1) road segments outside of any intersection functional area and (2) road segments inside of an intersection functional area. The POZ determining process 1400 of the predictive data analytics layer may first identify the type of road segments and may then calculate the POZ for that road segment. The system may determine at least one POZ for each road segment of each candidate route.

At 1402, the service computing device (e.g., computer device 1205 of vehicle 108) may receive vehicle information including current location and destination from the vehicle computing device, for example, as shown in connection with any of FIG. 13A, 13B, 15, or 16.

At 1404, the service computing device may determine candidate routes, waypoints, and functional areas of intersections, for example, as shown in connection with any of FIG. 13A, 13B, 15, or 16.

At 1406, the service computing device may determine a current segment based on waypoints, for example, as shown in connection with any of FIG. 13A, 13B, 15, or 16.

At 1408, the service computing device may determine whether the current segment is in the functional area of the intersection. If so, the process may proceed to 1416. If not, the process may proceed to 1410, for example, as shown in connection with any of FIG. 13A, 13B, 15, or 16.

At 1410, the service computing device may determine V (design speed) and G (road grade) for the current segment, for example, as shown in connection with any of FIG. 13A, 13B, 15, or 16.

At 1412, the service computing device may determine the stopping sight distance S based on the values for V and G determined at 1410 (see EQ(5) below), for example, as shown in connection with any of FIG. 13A, 13B, 15, or 16.

At 1414, the service computing device may determine POZ_{ST} for the current segment (e.g., segment is outside intersection functional area), for example, as shown in connection with any of FIG. 13A, 13B, 15, or 16.

At 1416, when the current segment is in the functional area of an intersection the service computing device 108 may determine a current zone of the functional area, e.g., the perception reaction distance zone, the maneuver distance zone, or the storage distance zone, for example, as shown in connection with any of FIG. 13A, 13B, 15, or 16.

At 1418, the service computing device may determine whether the vehicle is within the perception reaction distance zone. If so, the process may proceed to 1444. If not, the process may proceed to 1420, for example, as shown in connection with any of FIG. 13A, 13B, 15, or 16.

At 1420, when the vehicle is within the functional area of the intersection but not within the perception reaction distance zone, the service computing device may add the storage queue distance if available, for example, as shown in connection with any of FIG. 13A, 13B, 15, or 16.

At 1422, the service computing device may determine whether the vehicle should change lanes, such as based on the intended destination. If so, the process may proceed to 1424. If not, the process may proceed to 1426, for example, as shown in connection with any of FIG. 13A, 13B, 15, or 16.

At 1424, if the vehicle should change lanes, the service computing device may determine POZ_{M5} for the lane change (e.g., lane change inside functional area of intersection), for example, as shown in connection with any of FIG. 13A, 13B, 15, or 16.

At 1426, the service computing device may determine whether the vehicle should make a turn, for example, as shown in connection with any of FIG. 13A, 13B, 15, or 16. If so, the process may proceed to 1436. If not, the process may proceed to 1438.

At 1428, if the vehicle will be making a turn at the intersection, the service computing device may determine whether there is a traffic signal, for example, as shown in connection with any of FIG. 13A, 13B, 15, or 16. If so, the process may proceed to 1432. If not, the process may proceed to 1430.

At 1430, when there is not a traffic signal, the service computing device may determine POZ_{M3} for the intersection (e.g., turn at intersection with no traffic signal), for example, as shown in connection with any of FIG. 13A, 13B, 15, or 16.

At 1432, when there is a traffic signal, the service computing device may determine the condition of the traffic signal, for example, as shown in connection with any of FIG. 13A, 13B, 15, or 16.

At 1434, based on the determined condition of the traffic signal, the service computing device 108 may determine POZ_{M4} for the intersection (e.g., turn at intersection with traffic signal), for example, as shown in connection with any of FIG. 13A, 13B, 15, or 16.

At 1436, if the vehicle will not be making a turn at the intersection, the service computing device may determine whether there is a traffic signal, for example, as shown in connection with any of FIG. 13A, 13B, 15, or 16. If so, the process may proceed to 1440. If not, the process may proceed to 1438.

At 1438, when there is not a traffic signal, the service computing device may determine POZ_{M1} for the intersection (e.g., no turn at intersection with no traffic signal), for example, as shown in connection with any of FIG. 13A, 13B, 15, or 16.

At 1440, when there is a traffic signal, the service computing device may determine the condition of the traffic signal, for example, as shown in connection with any of FIG. 13A, 13B, 15, or 16.

At 1442, based on the determined condition of the traffic signal, the service computing device may determine POZ_{M2} for the intersection (e.g., no turn at intersection with traffic signal), for example, as shown in connection with any of FIG. 13A, 13B, 15, or 16.

At 1444, when the vehicle is within the perception reaction distance zone, the service computing device may determine whether the vehicle should change lanes, for example, as shown in connection with any of FIG. 13A, 13B, 15, or 16. If so, the process may proceed to 1448. If not, the process may proceed to 1446.

At 1446, when the vehicle was not going to change lanes, the service computing device 108 may determine POZ_{D2} for the current lane (e.g., no lane change), for example, as shown in connection with any of FIG. 13A, 13B, 15, or 16.

At 1448, when the vehicle is going to change lanes, the service computing device may determine POZ_{D1} for the new lane (e.g., change lanes), for example, as shown in connection with any of FIG. 13A, 13B, 15, or 16.

At 1450, following determination of the POZ at one of 1430, 1434, 1438, 1442, 1446, or 1448, the service computing device may perform at least one action based on at least the POZ, such as sending at least one signal, determining a POZ for a next segment of the candidate route, or the like, for example, as shown in connection with any of FIG. 13A, 13B, 15, or 16.

Further, while examples of determining POZs have been provided herein, additional examples are provided in U.S. patent application Ser. No. 17/476,529, filed on Sep. 16, 2021, and which is incorporated by reference herein.

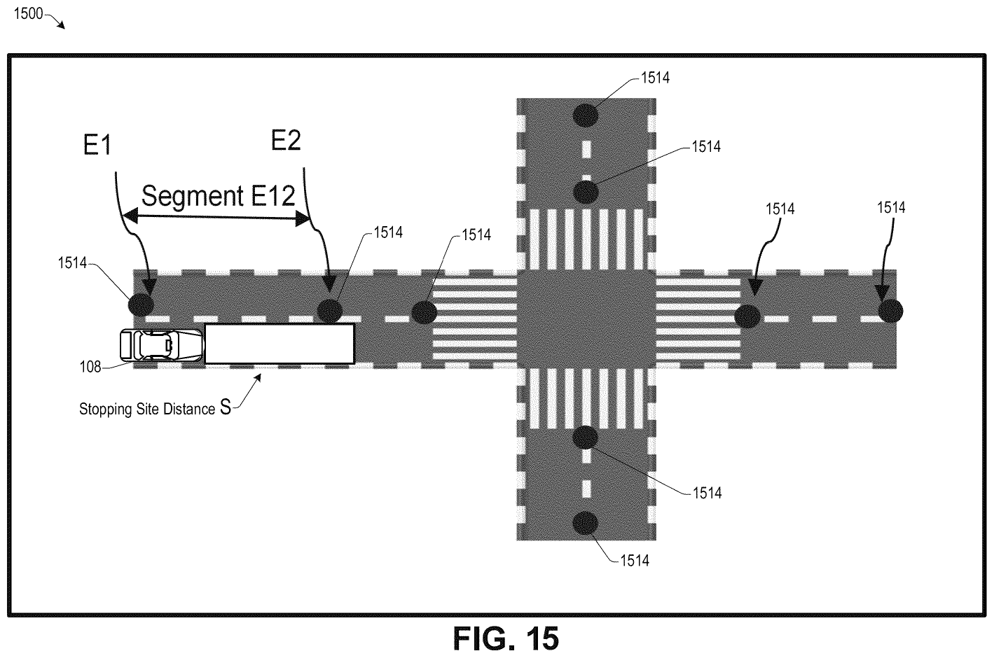

FIG. 15 illustrates an example 1500 of determining a POZ in which a current road segment falls outside of an intersection functional area according to some implementations. In this example, the vehicle 108 is located between a first waypoint 1514 designated as E1 and a second waypoint 1514 designated as E2. A plurality of other waypoints 1514 are also illustrated in this example. Accordingly, a road segment between the waypoints E1 and E2 may be designated as segment E12 in this example. Further, suppose that the road segment E12 is located outside the intersection functional area discussed above with respect to FIGS. 13A and 13B. When a road segment is located outside of an intersection functional area, stopping sight distance S for that road segment may be calculated as shown in EQ(3):

S=(1.47*V*t)+1.075*(V²/a) EQ(3)
where,
S=Stopping sight distance
V=Road design speed (mph)
t=Perception reaction time
a=Deceleration rate

In addition, EQ(3) can be rewritten as shown in EQ(4) based on the typical values of t=2.5 sec and a=11.2 ft/sec²:

S=3.675*V+0.096*V² EQ(4)

Additionally, in the situation that the road is on a grade G, the stopping sight distance S can take the grade into consideration and may be calculated as shown in EQ(5):

S=3.675*V+V²/[30((a/32.2)±G/100)] EQ(5)

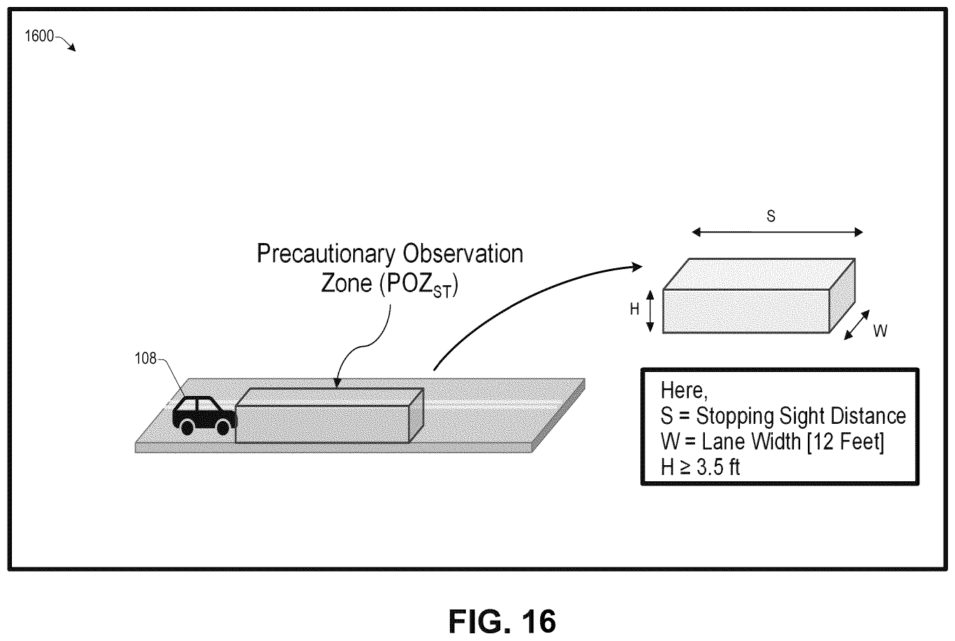

In some cases, the road design speed V and road grade G can be either stored in the data analytics platform database(s) for all routes or can be collected in real-time through third party services. Once the stopping sight distance S is calculated, the three-dimensional (3D) region of POZ_{ST} for the road segment outside the intersection functional area may be calculated as shown in FIG. 16 below, such as based on a lane width of 12 feet and a height of 3.5 ft.

FIG. 16 illustrates an example 1600 of determining a POZ according to some implementations. In this example, for road segments outside of intersection functional areas, the POZ is designated as POZ_{ST}, and may be determined as a volume in 3D space having a length corresponding to the stopping site distance S determined above with respect to FIG. 16; a width W corresponding to the width of the travel lane in which the vehicle 102 is traveling (or will travel), which in this example is a default value of 12 feet; and a height H, which in this example is a default height greater than or equal to 3.5 feet. In some examples, the height H may vary based on any of various factors, such as height of the vehicle, height of expected obstacles, signs, or signals, and so forth.

If a road segment falls inside of an intersection functional area, the next step is to identify its location on decision distance zone or ahead of the decision distance zone (maneuver and storage zone). In case the road segment is within decision distance zone of the intersection functional area, the system may identify whether the vehicle needs to make a lane change or not based on the next segments of destination routes. three-dimensional POZ_{D1} and POZ_{D2} for the current segment may be calculated considering 12 ft width of lane and 3.5 ft height of driver eye distance from road.

In case the current segment is ahead of the decision distance zone, it is considered to be in the maneuver distance zone. Note that, based on the road type, location and/or traffic, etc. storage length or queue length might be added in some intersections. The storage length of any intersection can be calculated based on the traffic history data. Additionally, storage length can be predicted for any time on the day based on the infrastructure sensor or camera data. Thus, once the current segment is within the intersection functional area but not within the decision distance zone, the queue length may be added if available. Consequently, the POZ may be calculated considering necessity of (further) lane change, making a turn or not, traffic signal intersection or sign-based intersection, etc. As explained above, e.g., with respect to FIG. 4, the POZ may be calculated in the predictive analytics layer for all road segments of all candidate routes. The POZ calculation can be done either in sequential or parallel computing modes. The POZs for the road segments may be stored in the map data database for future use. In this case, the POZ of any road segment immediately available in the map data database, and the system utilizes the stored POZs. The POZs determined for the respective road segments may be used to calculate the safety score for each road segment. To calculate the safety score, the 3D POZs of the road segments for every candidate route may be compared with vehicle sensor FOV. For each road segment, the percentage of 3D POZ covered (overlapped) by the vehicle sensor FOV is calculated. An average safety score percentage may be calculated for each candidate route by averaging the calculated percentage of overlap of the FOV for POZs of all road segments for that candidate route. This average percentage indicates the safety score of the entire route.

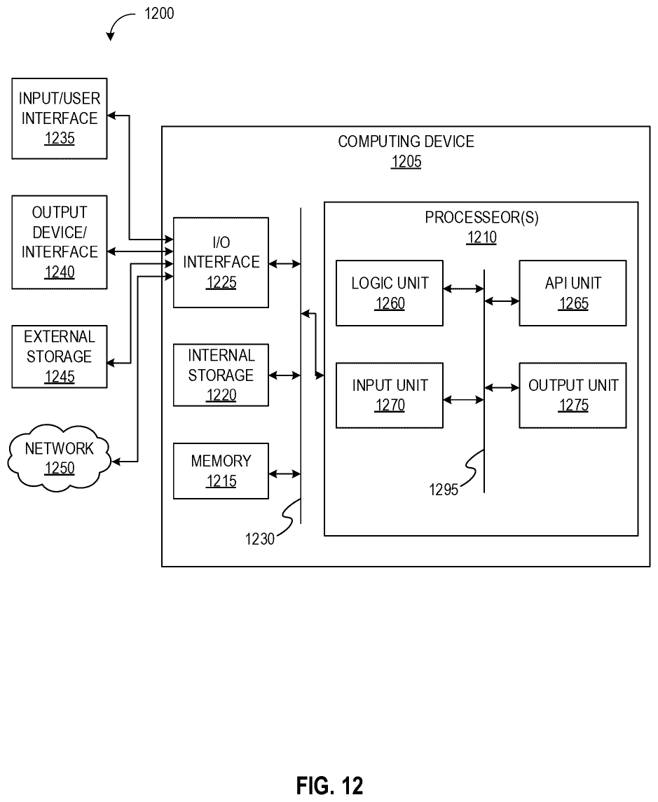

FIG. 12 illustrates an example computing environment with an example computer device suitable for use in some example implementations, such as the platform 402 as illustrated in FIG. 4. The computing environment can be used to facilitate implementation of the architectures illustrated in FIGS. 1-11. Further, any of the example implementations described herein can be implemented based on the architectures, APIs, microservice systems, and so on as illustrated in FIGS. 1-11. Computer device 1205 in computing environment 1200 can include one or more processing units, cores, or processors 1210, memory 1215 (e.g., RAM, ROM, and/or the like), internal storage 1220 (e.g., magnetic, optical, solid state storage, and/or organic), and/or I/O interface 1225, any of which can be coupled on a communication mechanism or bus 1230 for communicating information or embedded in the computer device 1205. I/O interface 1225 is also configured to receive images from cameras or provide images to projectors or displays, depending on the desired implementation.

Computer device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1225, input unit 1270, output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in example implementations.

Processor(s) 1210 can be configured to execute instructions for a method, the instructions involving receiving, from a connected automated electric vehicle (CAEV), vehicle information related to operation of the CAEV; determining one or more candidate routes to a destination of the CAEV based at least on the vehicle information; determining whether the CAEV is on a road segment of the one or more candidate routes to the destination having a dynamic charging system; and sending, to the CAEV, a path planning trajectory to update localization accuracy of the CAEV based on a battery of the CAEV being charged with the dynamic charging system along the one or more candidate routes, for example, in FIGS. 2 to 11.

Processor(s) 1210 can be configured to execute instructions for a method, the method involving determining a sensor field of view (FOV) of the CAEV based at least on the vehicle information; and determining an amount of computing resources of the CAEV based at least on the vehicle information, for example, in FIGS. 2 to 7.

Processor(s) 1210 can be configured to execute instructions for a method, the method involving determining the destination of the CAEV based on the vehicle information, wherein the destination is indicated within the vehicle information, for example, in FIGS. 2 to 6.

Processor(s) 1210 can be configured to execute instructions for a method, the method involving predicting the destination of the CAEV based on the vehicle information, wherein the destination is not indicated within the vehicle information, wherein the predicting the destination is based at least on one of a driver profile, a passenger profile, a vehicle profile, historic trip data, or a time of day, for example, in FIGS. 2 to 7.

Processor(s) 1210 can be configured to execute instructions for a method, wherein the determining the one or more candidate routes to the destination, the method involving determining one or waypoints and one or more road segments for each of the one or more candidate routes to the destination; and determining the one or more road segments comprising a dynamic charging system, wherein a number and a location of transmitter coils is detected for each of the one or more road segments comprising the dynamic charging system, for example, in FIGS. 2 to 7.

Processor(s) 1210 can be configured to execute instructions for a method, the method involving determining a safety score for each of the one or more road segments for automated driving (AD); and identifying a best route from the one or more candidate routes based at least on the safety score for the one or more road segments, for example, in FIGS. 2 to 7.

Processor(s) 1210 can be configured to execute instructions for a method, wherein in response to a determination that the road segment that the CAEV is on comprises the dynamic charging system, the method involving verifying a localization accuracy of the CAEV based on a receiver coil of the CAEV interacting with a transmitter coil of the dynamic charging system, wherein a location of the transmitter coil of the dynamic charging system is known such that a location of the CAEV is determined based on the CAEV engaging with the dynamic charging system, for example, in FIGS. 2 to 7.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
receiving, from a connected automated electric vehicle (CAEV), vehicle information related to operation of the CAEV;
determining one or more candidate routes to a destination of the CAEV based at least on the vehicle information;
determining whether the CAEV is on a road segment of the one or more candidate routes to the destination having a dynamic charging system; and
sending, to the CAEV, a path planning trajectory while identifying a localization accuracy of one or more sensors of the CAEV to update the localization accuracy of the CAEV based on a battery of the CAEV being charged with the dynamic charging system along the one or more candidate routes.

2. The method of claim 1, further comprising:
determining, using the one or more sensors of the CAEV, a sensor field of view (FOV) of the CAEV based at least on the vehicle information; and
determining an amount of computing resources of the CAEV based at least on the vehicle information.

3. The method of claim 1, further comprising:
determining the destination of the CAEV based on the vehicle information, wherein the destination is indicated within the vehicle information.

4. The method of claim 1, further comprising:
predicting the destination of the CAEV based on the vehicle information, wherein the destination is not indicated within the vehicle information, wherein the predicting the destination is based at least on one of a driver profile, a passenger profile, a vehicle profile, historic trip data, or a time of day.

5. The method of claim 1, wherein the determining the one or more candidate routes to the destination, further comprising:
determining one or waypoints and one or more road segments for each of the one or more candidate routes to the destination; and
determining the one or more road segments comprising a dynamic charging system, wherein a number and a location of transmitter coils is detected for each of the one or more road segments comprising the dynamic charging system.

6. The method of claim 5, further comprising:
determining a safety score for each of the one or more road segments for automated driving (AD); and
identifying a best route from the one or more candidate routes based at least on the safety score for the one or more road segments.

7. The method of claim 1, wherein in response to a determination that the road segment that the CAEV is on comprises the dynamic charging system, further comprising:
verifying a localization accuracy of the CAEV or the one or more sensors of the CAEV based on a receiver coil of the CAEV interacting with a transmitter coil of the dynamic charging system, wherein a location of the transmitter coil of the dynamic charging system is known such that a location of the CAEV is determined based on the CAEV engaging with the dynamic charging system, wherein sensor calibration parameters or threshold values are updated to avoid localization error.

8. A non-transitory computer readable medium, storing instructions for execution by one or more hardware processors, the instructions comprising:
receiving, from a connected automated electric vehicle (CAEV), vehicle information related to operation of the CAEV;
determining one or more candidate routes to a destination of the CAEV based at least on the vehicle information;
determining whether the CAEV is on a road segment of the one or more candidate routes to the destination having a dynamic charging system; and
sending, to the CAEV, a path planning trajectory while identifying a localization accuracy of one or more sensors of the CAEV to update the localization accuracy of the CAEV based on a battery of the CAEV being charged with the dynamic charging system along the one or more candidate routes.

9. The non-transitory computer readable medium of claim 8, the instructions further comprising:
determining, using the one or more sensors of the CAEV, a sensor field of view (FOV) of the CAEV based at least on the vehicle information; and
determining an amount of computing resources of the CAEV based at least on the vehicle information.

10. The non-transitory computer readable medium of claim 8, the instructions further comprising:
determining the destination of the CAEV based on the vehicle information, wherein the destination is indicated within the vehicle information.

11. The non-transitory computer readable medium of claim 8, the instructions further comprising:
predicting the destination of the CAEV based on the vehicle information, wherein the destination is not indicated within the vehicle information, wherein the predicting the destination is based at least on one of a driver profile, a passenger profile, a vehicle profile, historic trip data, or a time of day.

12. The non-transitory computer readable medium of claim 8, the instructions further comprising:
determining one or waypoints and one or more road segments for each of the one or more candidate routes to the destination; and
determining the one or more road segments comprising a dynamic charging system, wherein a number and a location of transmitter coils is detected for each of the one or more road segments comprising the dynamic charging system.

13. The non-transitory computer readable medium of claim 12, the instructions further comprising:
determining a safety score for each of the one or more road segments for automated driving (AD); and
identifying a best route from the one or more candidate routes based at least on the safety score for the one or more road segments.

14. The non-transitory computer readable medium of claim 8, wherein in response to a determination that the road segment that the CAEV is on comprises the dynamic charging system, the instructions further comprising:
verifying a localization accuracy of the CAEV or the one or more sensors of the CAEV based on a receiver coil of the CAEV interacting with a transmitter coil of the dynamic charging system, wherein a location of the transmitter coil of the dynamic charging system is known such that a location of the CAEV is determined based on the CAEV engaging with the dynamic charging system, wherein sensor calibration parameters or threshold values are updated to avoid localization error.

15. A system, comprising:
a connected automated electric vehicle (CAEV); and
a processor, configured to:
receive, from a connected automated electric vehicle (CAEV), vehicle information related to operation of the CAEV;
determine one or more candidate routes to a destination of the CAEV based at least on the vehicle information;
determine whether the CAEV is on a road segment of the one or more candidate routes to the destination having a dynamic charging system; and
send, to the CAEV, a path planning trajectory while identifying a localization accuracy of one or more sensors of the CAEV to update the localization accuracy of the CAEV based on a battery of the CAEV being charged with the dynamic charging system along the one or more candidate routes.

16. The system of claim 15, the processor configured to:
determine, using the one or more sensors of the CAEV, a sensor field of view (FOV) of the CAEV based at least on the vehicle information; and
determine an amount of computing resources of the CAEV based at least on the vehicle information.

17. The system of claim 15, the processor configured to:
determine the destination of the CAEV based on the vehicle information, wherein the destination is indicated within the vehicle information.

18. The system of claim 15, the processor configured to:
predict the destination of the CAEV based on the vehicle information, wherein the destination is not indicated within the vehicle information, wherein the predicting the destination is based at least on one of a driver profile, a passenger profile, a vehicle profile, historic trip data, or a time of day.

19. The system of claim 15, wherein the determining the one or more candidate routes to the destination, the processor configured to:
determine one or waypoints and one or more road segments for each of the one or more candidate routes to the destination; and
determine the one or more road segments comprising a dynamic charging system, wherein a number and a location of transmitter coils is detected for each of the one or more road segments comprising the dynamic charging system.

20. The system of claim 19, the processor configured to:
determine a safety score for each of the one or more road segments for automated driving (AD); and
identify a best route from the one or more candidate routes based at least on the safety score for the one or more road segments.
